(19) United States
(12) Patent Application Publication
(10) Pub. No.: US 2004/0157046 A1
(43) Pub. Date: Aug. 12, 2004

(54) Gaming ticket

(76) Inventors: William A. Becker JR., Lockport, NY (US); Peter Biondi, East Amhert, NY (US); Dan Fallin, Grand Island, NY (US)

Correspondence Address: Mark S. Leonardo, Esq., Brown Rudnick Berlack Israels LLP, One Financial Center, Boston, MA, 02111, US

(21) Appl. No.: 10/701,941

(22) Filed: Nov. 5, 2003

Related U.S. Application Data
(60) Provisional application No. 60/446,389, filed on Feb. 10, 2003.

(51) Int. Cl. B32B 3/00

(52) U.S. Cl. 428/195.1

(57) ABSTRACT

An apparatus and process that provides a versatile instant gaming ticket stock that can further adapt to marketing and promotional efforts. The ticket stock is a multi layered gaming ticket having a thumb notch allowing a player to remove an outer layer revealing whether or not they are a winner. The multi-layer ticket is fashioned in a manner that prior to printing, the inside of the ticket is blank and has no inherent value. The multi-layer ticket stock allows point of receipt thermal printing of gaming or coupon information to a hidden inner layer of the assembled ticket producing a tamper proof ticket.

### RELATED APPLICATION INFORMATION

This patent application claims priority to U.S. application Ser. No. 60/446,389, filed on Feb. 10, 2003, the entire contents of which is incorporated herein by reference.

### FIELD OF INVENTION

The present invention relates to instant gaming ticket stock where at the point of purchase or receipt the ticket stock is provided with a blinded method of inserting gaming or coupon information upon purchase thereof. More particularly, a multi layer ticket is disclosed having layers allowing for thermal printing of gaming information without revealing such gaming information until the time of separation by the purchaser.

### BACKGROUND OF INVENTION

Lottery tickets are a popular form of gaming entertainment that are in either in the form of scheduled drawings occurring on a weekly or daily basis or instant lottery tickets where results can be obtained immediately after purchase. Instant lottery tickets are popular with state gaming authorities as a means of revenue and have more recently become a popular form of incentives within the marketing arena for purchasers of food and goods. Most particularly, instant lottery tickets have become increasingly popular as they allow players to immediately know the results of whether or not their tickets entitle them to cash or other prizes. This instant aspect of the outcome gaming results allows sellers of tickets to benefit in the excitement and multiple plays that are characteristic of instant lotteries. These multiple plays increase revenues by allowing the player to enjoy the excitement of instant results.

As a marketing tool, these instant chance tickets allow merchants to entice and excite shoppers within the retail environment. The instant nature of these chance cards allow shoppers to immediately enjoy the benefit of free goods, cash prizes or discounted goods within the shopping environment. Their use and benefit within the retail environment is attested to by their growing popularity within national fast food and retail establishments.

Typically, a purchaser of an instant game ticket determines whether or not they have won by scratching off an opaque layer covering gaming results. Beneath the opaque layer lies outcome gaming information that reveals the results of the instant game. These opaque layers are usually layers of specialized removable inks that are scratched off with a coin or sharp object. These instant lottery tickets imitate many forms of popular games of chance or sports that include but are not limited to casino games, horse races or the mere matching of numbers. Undesirably, these specialized removable inks are often difficult to remove sometime causing the gaming information to be obliterated.

Unfortunately, conventional prior art instant tickets are printed with predetermined gaming information prior to the purchase by the prospective player. Because gaming information is placed upon instant tickets prior to point of purchase, these tickets have inherent value. As a result of this inherent value, the distribution of these tickets is fraught with fraud and theft. This inherent value with prior art gaming tickets creates a gaming ticket that has inherent value as is passes through normal means of distribution. From outright theft of these instant gaming tickets via robbery or burglary, to the embezzlement of these tickets by clerks or employees having access to them, the inherent value of these tickets creates risk of theft or diversion within the distribution system.

Additionally, it has been noted that since these instant tickets have gaming information preprinted, various schemes and methods have been utilized by vendors to determine whether or not the instant tickets in their possession have worth beyond the face value. While various attempts have been made to prevent against theft, diversion or damage to the integrity of the games themselves, lottery and gaming officials have increasingly found that their attempts to prevent the problems as noted above are met with increasing difficulties.

The preprinted nature of gaming information creating inherent value along with the large variety of these games causes vendors to have significant inventory requirements and risks. Furthermore, the preprinted nature of the tickets creates a system of accounting and inventory that is manual and burdensome to the vendor.

Unfortunately, most prior attempts to produce a gaming ticket stock that acquires gaming information at the point of purchase and which can be used as an instant lottery ticket have been met with limited success. Current instant lottery tickets have the benefit of appealing and enticing graphics. These graphics further promote the excitement of the ticket and have marketing tie-ins to the promoted game. Prior attempts at instant point of sale tickets have resulted in bland and generally unappealing graphics. Furthermore, prior art point of purchase instant lottery tickets that have relied on thermal printing of gaming information have been problematic to the electronic gaming machines. Additionally, the thermal process of printing these prior art tickets have resulted in telltale signs of the hidden gaming information thereby undermining the integrity of the game itself.

### SUMMARY OF INVENTION

The invention of the present disclosure provides a versatile instant gaming ticket that can also be adapted to instant lottery, marketing and promotional efforts. The invention is a multi-layered gaming ticket having a notched portion allowing a player to remove an outer layer revealing whether or not they are a winner. According to the invention, the multi-layer ticket is produced in a manner that immediately prior to sale or distribution to the end user, the inside of the ticket is devoid of gaming information. The inventive multi-layer ticket allows thermal printing of gaming information or coupon information to a masked inner layer of the assembled ticket producing a tamper proof ticket. Because of various coatings that are applied to the ticket stock, the printed results of the instant gaming ticket are not known until a player grasps an outer film layer at a notched portion (e.g., thumb notch) and removes this outer film layer revealing information and/or results hidden below a previously occluded section contained within the outer film layer. The inventive multi-layered ticket is comprised of various layers that allow the outcome gaming information to be printed at the time of purchase.

Advantageously, the ticket stock allows vivid and attractive graphics to be printed in a multiple color printing process. This printing process upon the outermost layer of the ticket stock provides no indication of the contents of the covered inner layer containing the outcome information sought by the player or participant. The inventive multi-layered ticket is further comprised of thermal ticket stock having a release coating allowing the outcome information sought to be unaffected or compromised by the removal of the outer film layer.

The inventive gaming ticket stock is so configured that the removable outer film may contain both a clear portion and an opaque portion or be completely opaque. The clear portion or completely opaque area allows desired promotional graphics to be placed upon the outer area of the inventive ticket stock. Additionally, the opaque portion of the removable film containing the game results is further masked with graphics, which allows information to be printed in a manner that is undetectable until removed by the player or participant. The outer removable film is coated with a protective clear coat polymer that prevents damage to the thermal print head.

Additionally, the use of serialized bar-codes or other thermally imaged verification schemes according to the present disclosure could be employed to aid in anti-fraud security.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIGS. 1 depicts the multi-layered construction of the inventive ticket stock;

FIGS. 2-3 are a schematic view of the assembly of the various layers to the inventive ticket stock;

FIG. 4 is an overhead view of the top layer comprised of polyester film having metallized chrome strips to opaque the gaming information;

FIGS. 5-6 are a schematic view of the printing of graphics upon the inventive gaming ticket stock;

FIG. 7 is an overhead view of the perforation and folding of the inventive gaming ticket stock prior to placement within a gaming machine;

FIG. 8A is a front planar view of a gaming ticket prior to being thermally imaged according to the present disclosure;

FIG. 8B is a front planar view of the gaming ticket of FIG. 8A after being thermally imaged;

FIG. 8C is a front planar view of the gaming ticket of FIG. 8A showing the removal of an overlaying film substrate; and

FIG. 8D is a front planar view of the gaming ticket of FIG. 8A showing a revealed thermal image.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

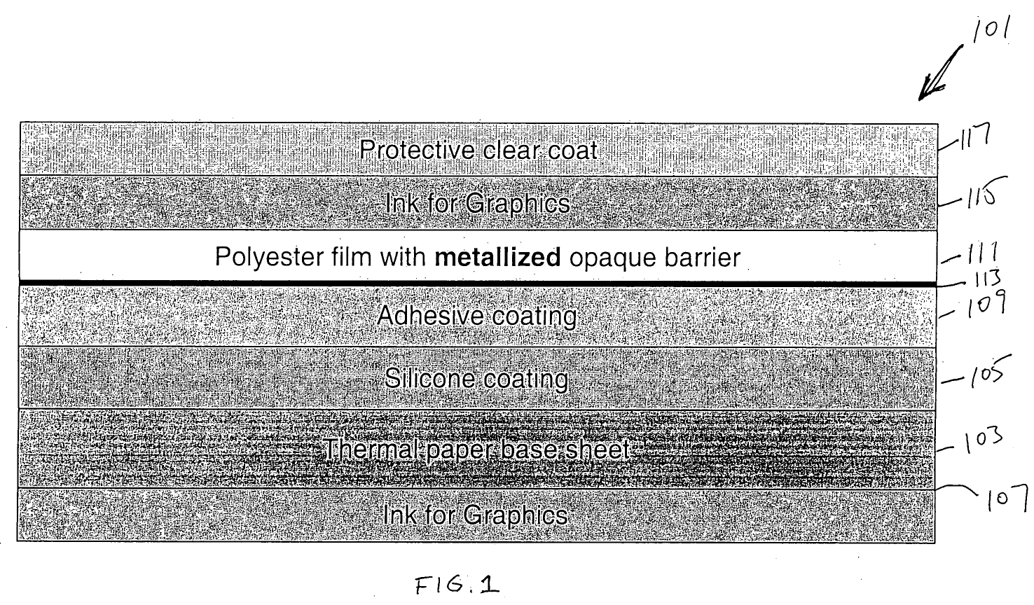

An apparatus and method in accordance with present invention for the production and construction of an instant lottery ticket or instant coupon is illustrated in FIG. 1. Turning to FIG. 1, a side view of the inventive multi-layered ticket stock 101 is depicted. This multi-layered ticket stock 101 is created by the application of various layers or coatings upon a thermal paper base sheet 103. The thermal paper base sheet 103 is approximately 4.5 mil (0.0045″) stock (where 1 mil is defined as 0.001″) having a thermally-sensitive surface finish. It is contemplated within the scope of the invention that either thicker or thinner thermal card stock can be used depending upon the requirements of the gaming machine or coupon machine that is used.

The thermal paper base sheet 103 is coated with a release layer 105 in the form of a silicone coating. This release layer 105 acts a protective coating for the thermal paper and allows the integrity of any thermal imprint to be preserved. The release layer's 105 silicone coating is a combination of a silicone-epoxy copolymer mixed with a cationic photoinitiator that are both curable by ultraviolet (UV) irradiation.

Silicone-epoxy copolymers are organo-functional polydimethylsiloxane (PDMS) polymers where methyl groups are replaced with reactive organic moieties including acrylate, oxirane, or other readily polymerizable groups. The UV curable silicone copolymer component contemplated as a silicone coating in the inventive ticket stock 101 is sold as a paper release coating by Rhodia Silicones, Rock Hill S.C, under the Silcolease® trade name. These radiation curable silicone copolymers by Rhodia include but are not limited to Silcolease PC-675, Silcolease PC-670, Silcolease PC-600 and Silcolease PC-601. Radiation curable silicone-epoxy copolymer materials are also sold by GE silicones under various trade names. It is contemplated within the scope of the invention that other silicone materials that are rapidly cured by some form of irradiation may be used. It is further contemplated within the scope of the invention that other silicone coatings known in the art that are not cured by irradiation may also be used.

These radiation-cure epoxy silicones are used with compatible cationic photoinitiator such as onium type photocatalyst. The compatible onium salt photocatalyst utilized to catalyze the curing of the epoxy silicone in the process of the present invention may be any onium salt photocatalyst known within the art. It is contemplated within the scope of the invention that the following bisaryliodonium salt catalysts may be used, these include but are not limited to bis(dodecylphenyl) iodonium hexafluoroantimonate, bis(dodecylphenyl) iodonium hexafluoroarsenate and (4-octyloxyphenyl)(phenyl) iodinium hexafluoroantimonate. The cationic photoinitiator materials used in the inventive ticket stock are sold by Rhodia Silicones, Rock Hill S.C., under the Silcolease® trade name. These photoiniators by Rhodia Silicones include but are not limited to Silcolease PC-702, Silcolease PC-700 and Silcolease PC-702-30. It is contemplated within the scope of the invention that other onium type catalysts photoinators may be used. Because these cationic systems containing a radiation curable epoxy silicone and a photoinator are rapidly cured when exposed to irradiation, they are desirable in a high output manufacturing process.

It is contemplated within the scope of the invention that other silicone products may be used to create the release layer 105. Silicone components that can be used to create this protective coating over the thermal paper base sheet 103 that are contemplated within the scope of the invention include, but are not limited to, the following: NuSil MED-361, NuSil MED-4162, which are silicone dispersion products having a silicone ingredient that is dispersed within an organic solvent. Additionally, other polydimethylsiloxane copolymers may be used such as, methyltrimethoxy silane, methyltriacetoxy silane, silicone chloride, vinyl trimethoryl silane, bis(trimethoxysilyl) propyl amine, gamma-ureidopropyl trimethoxy silane and organosilane ester tri (3-(trimethoxysilyl) propyl) isocyanurate, or the like. It is contemplated within the scope of the invention that any polymethyl siloxane known in the art may be used to provide for the release coating 105 over the thermal paper base sheet 103.

Below the thermal base sheet 103 opposite the thermal sensitive surface is a non-thermal sensitive surface 107 that forms the bottom of the inventive gaming ticket stock. This non-thermal sensitive surface 107 provides a surface within the inventive ticket stock 101 for the printing of three color ink graphics. It is contemplated within the scope of the invention that further multiple ink graphics can be applied to this non-thermal sensitive surface 107. This non-thermal sensitive surface 107 is generally reserved for text and graphics concerning rules and conditions of the instant game or coupon; however, the non-thermal sensitive surface 107 can further be used to print colorful promotional graphics and text as well. The non-thermal sensitive surface 107 may further contain a printing cue block that allows the operator of the gaming or coupon machine to properly position the ticket stock 101 within the thermal printing device. The present disclosure is also contemplated for gaming tickets having two or double sided thermal printing and usage.

Above the release layer 105 is a clear adhesive coating 109. Various permanent or non-permanent adhesives known in the art may be used. For example, hot melt rubber, emulsion acrylic, emulsion rubber, solvent based, silicone based, UV or EB cured. This clear adhesive coating 109 allows non permanent attachment of a polyester film 111. The polyester film 111 can be any polymeric clear film having a thickness about 0.01 mil (0.00001″) to about 1.5 mil (0.0015″). An optional strip opaque barrier 113 is contained within polyester film 111. This optional strip opaque or full coverage opaque barrier 113 can be a metallized coating applied to the film lamination or non removable barrier inks or both. The opaque barrier 113 is positioned within the polyester film 111 in a manner that occludes the thermal imprinting of gaming information, coupon information and identifiers such as bar codes or serial numbers.

According to the invention, the polyester film 111 is receptive to a three ink printing process. This ink printing process can be used to place graphic ink 115 for purposes that include, but are not limited to, promotional graphics, text or identifiers such as bar codes or serial numbers. The graphic ink 115 is placed upon the instant ticket stock 101 in all viewable areas of the ticket. For example, printing may be performed in colored ink so as to cause eye confusion. Upon purchase by a lottery player or coupon recipient, the gaming ticket stock 101 is run through a gaming machine or coupon machine. The outcome information of the lottery ticket or coupon is thermally printed upon the thermal sensitive surface of the thermal paper base sheet 103 with a corresponding identifier such as a serial number or bar code. The graphic ink 115 may further create a printing cue block that allows the operator of the gaming or coupon machine to properly position the ticket stock 101 within the thermal printing device.

A further layer comprising a protective clear coat 117 is placed over the graphic ink 115 and the opaque barrier strip 113. This protective clear coat 117 can be any polymeric compound that is clear. For example, such compounds may include water based flexo varnishes (clear inks) and UV cured fleco varnishes (clear inks) as well as EB cured coatings, Offset or UV offset inks/varnishes, letterpress inks, screen printing or other commercially available printing process inks and coatings. The protective clear coat 117 may consist of protective varnishes, urethanes or protective silicone coatings. This protective clear coat 117 protects the thermal print head of the gaming or coupon machine. It further acts to prevent the jamming or dragging of the ticket stock 101 through the thermal printing device.

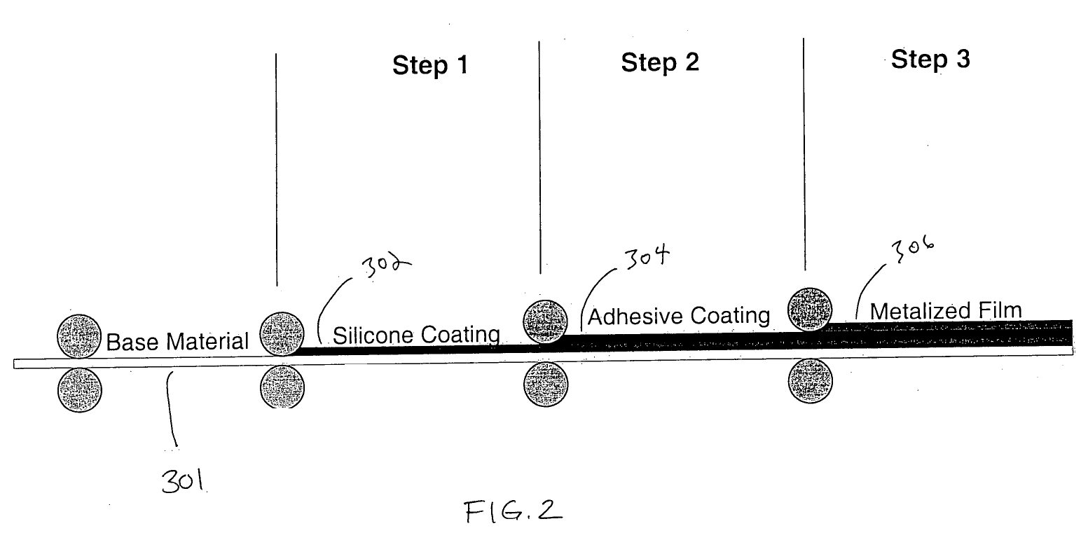

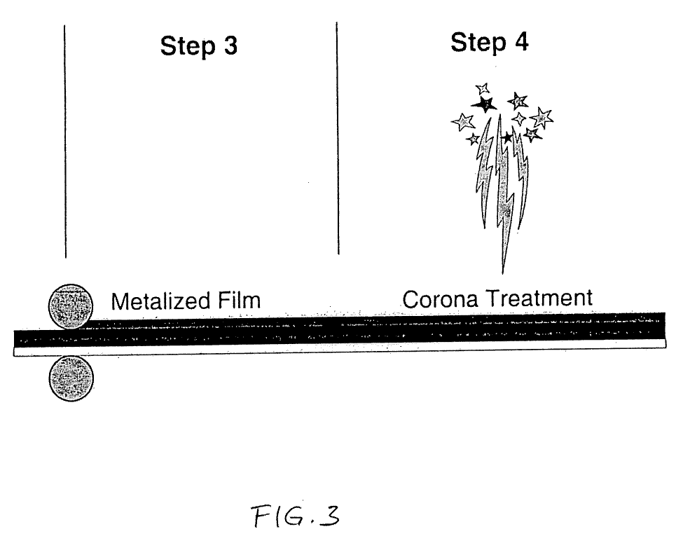

Referring to FIGS. 2-3, a method of preparing the inventive lottery ticket stock is shown. Turning to FIG. 2 a conventional thermal paper base stock 301 is shown. The thermal paper base stock 301 is supplied on a continuous roll having a thermal sensitive surface and a non-thermal sensitive surface. Alternately, the present disclosure provides for thermal sensitive stock on both sides of the gaming ticket.

As shown in FIGS. 2-3, the thermal paper base stock 301 is inserted into an assembly process that allows a silicone coating 302 to be applied to the thermal sensitive surface. The silicone coating 302, which is UV curable, is applied over the thermal sensitive surface of the thermal paper base stock 301. This silicone coating 302 is formed from an epoxy silicone co-polymer as described above. The silicone coating 302 provides the thermal paper base stock 301 with a protective coating that serves as a release coating. Within one illustrative embodiment, the silicone coating 302 is cured by exposure of the silicone coating 302 to UV irradiation. It is contemplated within the scope of this invention that other forms of irradiation known in the art may be used. Within the manufacturing process, these UV curable silicones that form the coating are known as paper release coatings. Their ability to be rapidly cured upon exposure to UV irradiation is advantageous to the high speed manufacturing process.

After the application and curing of the silicone coating 302, the coated thermal paper base stock 301 is further coated within an adhesive coating 304. The adhesive coating 304 has the composition as described above. The adhesive coating allows a subsequent metallized film 306 coating to be removed without damage to any thermal impression within the thermal paper base stock 301. The non-permanent nature of the adhesive coating is based on adhesive type. For example, a permanent adhesive with a light weight coating. Thus, non-permanence is achieved by adhesive selection plus a silicone release coating.

As shown in FIG. 3, a polymeric metallized film 306 is then placed upon the adhesive coating 304. This polymeric metallized film 306 occludes information that may be printed upon the thermal paper base stock 301. The assembled layers 310, 302, 304 and 306 are then exposed to irradiation curing the silicone coating 302.

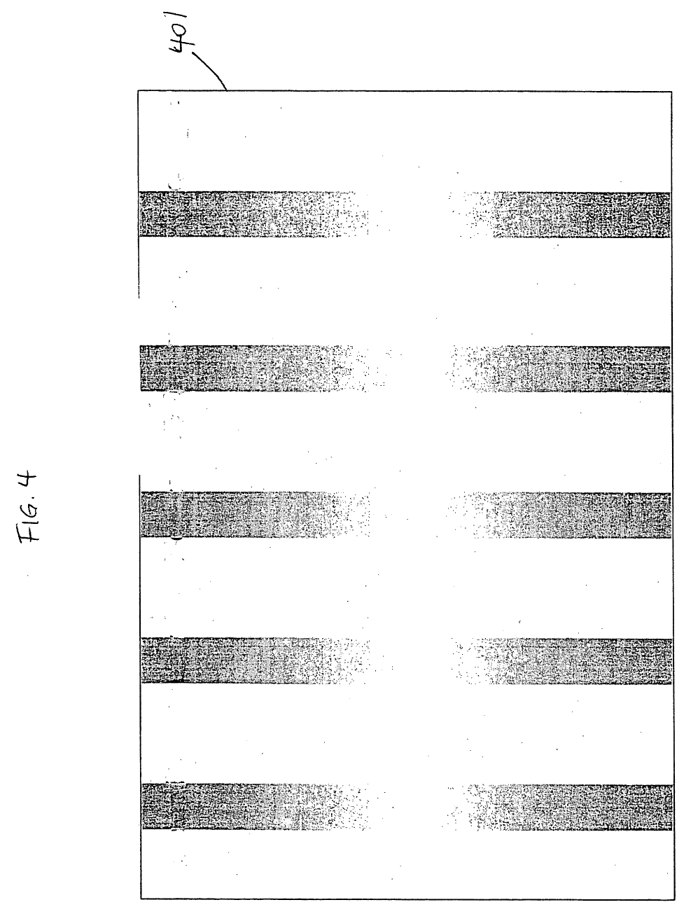

Turning to FIG. 4, a clear polyester film 401 having chrome like metallized surface, full or partial in coverage, is shown. As shown in FIGS. 2-3, the clear polyester film 306 provides a lamination of the inventive gaming ticket stock. The clear polyester film 306 is applied over the adhesive coating 304 in a manner that allows the polyester film to be removed at a later point. The later removal of this clear polyester film 306, which forms the laminating surface, does not affect the integrity of images within the thermal paper stock 301.

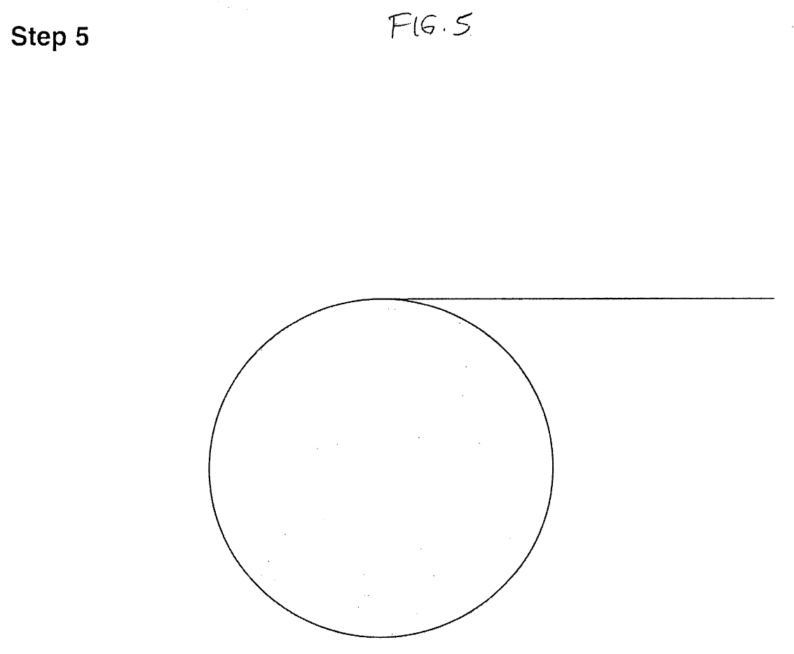

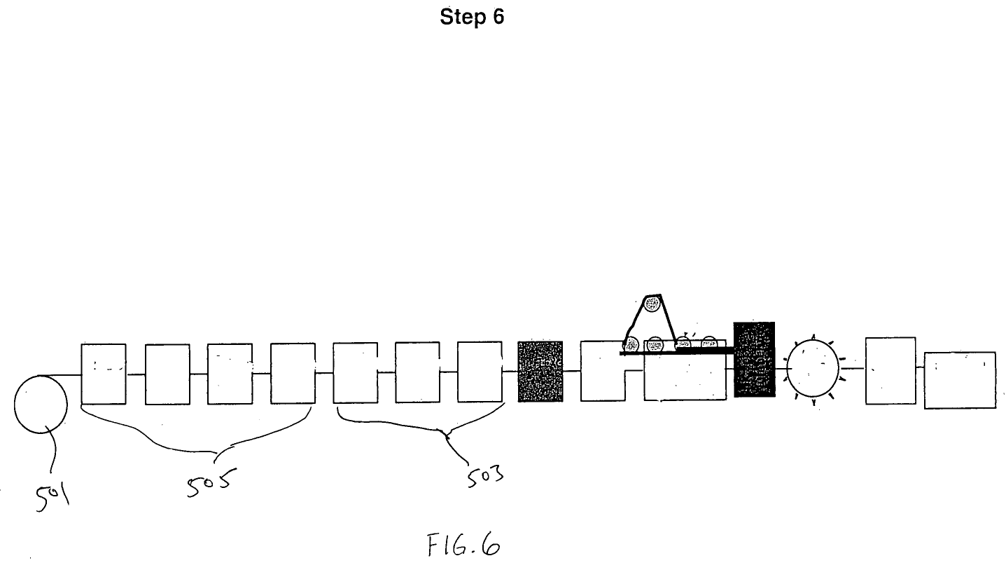

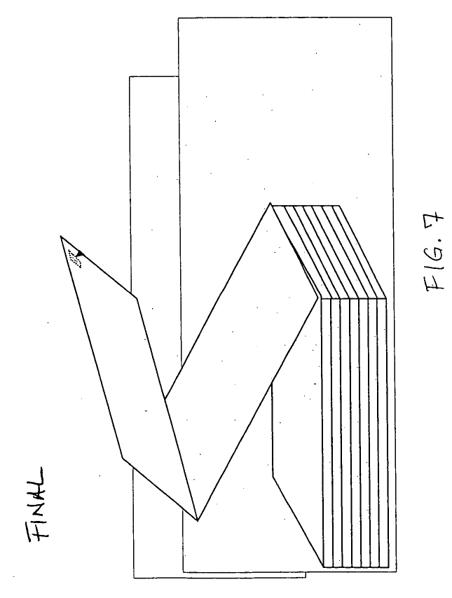

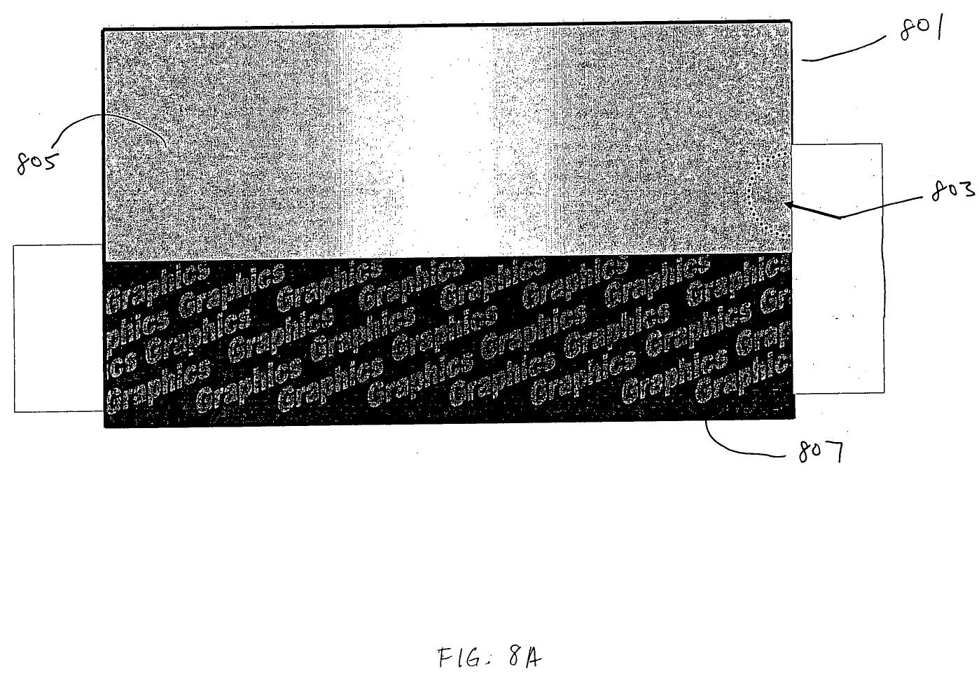

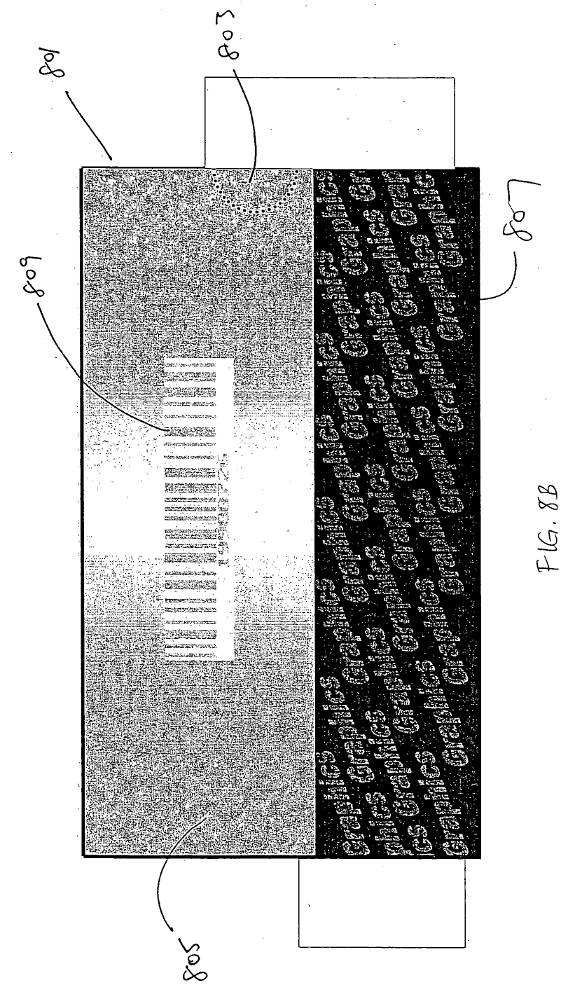

The laminated ticket stock 501 then goes to a printing press, as shown in FIGS. 5 and 6, and undergoes printing of graphics upon the surface of the polyester film 503 and printing of graphics upon the non-thermal sensitive surface 505 of thermal paper base stock. After the graphics are printed upon the ticket stock, a protective coating is applied to the printed laminated surface. This protective coating prevents damage to the thermal printing head of gaming or coupon machines.

As shown in FIG. 7, completed ticket stock 701 is configured to a particular gaming or coupon machine to be used. The ticket stock can be configured to be in a continuous roll, individual tickets or fan folded depending upon the requirements of the gaming or coupon machine.

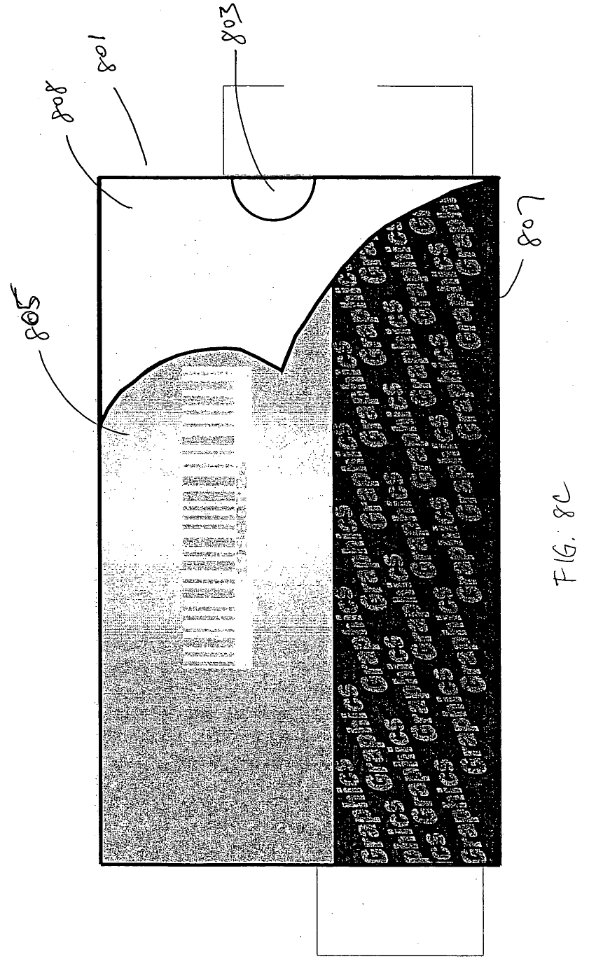

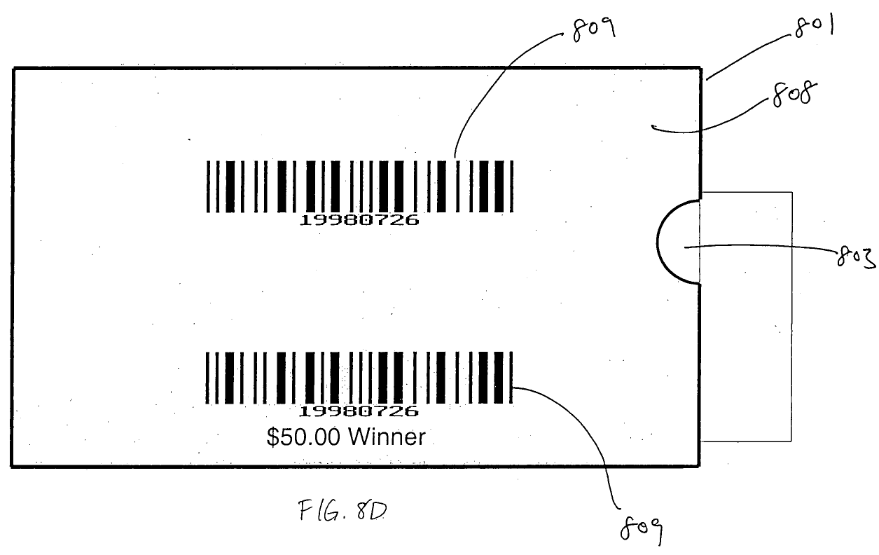

Turning to FIGS. 8A-8D, an inventive gaming ticket 801 according to the invention is shown. A top view of the inventive gaming ticket 801 is shown in FIG. 8A. The inventive gaming ticket 801 has a thumb notch 803 allowing a player the ability of revealing gaming information (not shown) by the removal of a top layer 805 formed of polymeric material. The top layer 805 may contain promotional or informational graphics 807. Upon purchase, the player removes the top layer 805 by grasping the thumb notch 803 revealing a bottom layer comprised of thermal ticket stock 808. The top layer 805 contains opaque material, such as a metallized film, that occludes information thermally printed upon the thermal ticket stock 808. It is contemplated within the scope of the invention that the opaque material can cover a substantial portion of the top layer 805 or can be strategically placed within the top layer 805 to occlude gaming information contained within the thermal ticket stock 808.

As shown in FIG. 8B, gaming information 809 is thermally imprinted upon the thermal ticket stock 808. Gaming information 809 includes, but is not limited to, gaming results, serial numbers and bar codes, may be imprinted using thermal printing methods known in the art. Although a bar code with a corresponding serial number is shown in FIG. 8b, in actual use of the inventive gaming ticket such information is occluded by the use of the top layer 805 containing opaque material.

Turning to FIG. 8C, the removable nature of the top layer 805 of the inventive gaming ticket 801 is depicted. The thumb notch 803 is grasped by a player, and the top layer 805 comprised of metallized film is peeled away from the thermal ticket stock 808. It is contemplated within the scope of the invention that the player can remove the entire top layer 805 or portions thereof. As shown in FIG. 8D, upon removal of the top layer 805, gaming information 809 contained within the thermal ticket stock 808 is visible to the player. The gaming information 809 is protected from alteration or destruction by the silicone coating that further protects the gaming information 809 upon removal of the top layer 805.

The gaming ticket stock according to the present disclosure is utilized by vendors of instant lottery tickets or retail establishments offering promotional instant coupons. The gaming ticket stock, upon purchase by a player, is processed through an electronic lottery machine that thermally prints the outcome information upon a selected area of the inventive gaming ticket stock that is covered by an opaque barrier. In the case of a coupon machine, a patron upon completion of a qualifying event, is given a ticket printed through the coupon machine. Once again, the outcome information is thermally printed below the opaque barrier.

Advantageously, the gaming ticket stock prior to purchase by the player or receipt by a patron has no inherent value. Only upon purchase of an instant lottery ticket or qualification of receipt of an instant coupon is value imparted to the ticket stock. At such time of receipt by a player, the thermal printer of the gaming machine thermally imprints outcome information and a corresponding serial number or identifier.

The electronic gaming machine can be networked electronically to a central gaming office or merchandising office. This networking of the remote gaming or coupon machines results in a central control of the outcome information printed upon the instant ticket stock. It is contemplated within the scope of the invention that the electronic gaming or coupon machines can also function as stand alone devices.

The point of purchase gaming or coupon machine according to the invention, allows a vendor to have complete electronic control and tracking of tickets produced by the gaming terminal. This electronic control alleviates the problem of theft or diversion and allows the vendor to identify and correspond to the operator of the gaming machine those tickets purchased.

The foregoing has been a description of certain specific embodiments of the present disclosure. The present disclosure is not to be limited in scope by the illustrative embodiments described which are intended as specific illustrations of individual aspects of the disclosure, and functionally equivalent methods and components are within the scope of the invention. Indeed, various modifications of the disclosure, in addition to those shown and described herein will become apparent to those skilled in the art from the foregoing description and all such modifications are included.

What is claimed is:

1. A gaming ticket assembly comprising:
a thermal paper base stock having a first surface and a second surface said first surface being thermally sensitive and said second surface be non thermally sensitive or thermally sensitive;
a silicone coating covering said first surface of said thermal paper base stock; an adhesive coating covering said silicone coating;
a polymeric film having a opaque barrier area, said polymeric film being releasably attached to said adhesive coating; and
a protective coating covering said polymeric film.

2. The gaming ticket according to claim 1 wherein said silicone coating is curable by irradiation.

3. The gaming ticket according to claim 1 wherein said opaque barrier is a metallized film applied to said polymeric film.

4. The gaming ticket according to claim 1 wherein said silicone coating is formed from a epoxy silicone co-polymer.

5. The gaming ticket according to claim 1 wherein said protective coating is selected from the group consisting of inks, urethanes, varnishes and silicone.

6. The gaming ticket according to claim 1 wherein said opaque barrier masks gaming information.

7. The gaming ticket according to claim 1 wherein said polymeric film is receptive to a color printing process.

8. The gaming ticket according to claim 1 wherein said gaming ticket is used for instant lottery tickets.

9. The gaming ticket according to claim 1 wherein said gaming ticket includes a notched portion.

10. A method of producing gaming ticket stock comprising the steps of:
providing a thermal paper base sheet having a thermal sensitive surface and a non thermal sensitive surface;
coating said thermal sensitive surface with a silicone coating;
applying an adhesive coating to said silicone coating;
attaching a polymeric film to said adhesive coating, said polymeric film having an opaque barrier area;
applying printed graphics to said polymeric film; and
coating said polymeric film with a protective coating.

11. The method of producing a gaming ticket according to claim 10 wherein said opaque barrier is formed by a metallized film, ink, or an opaque film.

12. The method of producing a gaming ticket according to claim 10 wherein said opaque barrier area masks thermally imprinted gaming information.

13. The method of producing a gaming ticket according to claim 10 wherein said silicone coating is an epoxy silicone coating that is curable by irradiation.

14. The method of producing a gaming ticket according to claim 10 wherein said opaque barrier is created by a permanent occluding ink.

15. The method of producing a gaming ticket according to claim 10 further comprising a step of printing graphics on said non thermal surface of said thermal paper base stock.

16. The method of producing a gaming ticket according to claim 10 wherein said printing graphics are performed with one or more color ink process.

17. The method of producing a gaming ticket according to claim 10 further comprising the step of printing a printing clue block on said polymeric film.

18. The method of producing a gaming ticket stock according to claim 10 wherein said gaming ticket stock is used for instant lottery tickets.

19. A method of vending an instant gaming ticket stock comprising the steps of:
producing a multi-layered gaming ticket according to claim 10 and further including the steps of:
inserting said multi-layered gaming ticket into a computerized gaming machine;
imprinting said multi-layered gaming ticket with game of chance outcome information below said opaque barrier said outcome information containing an unique identifier with thermal printing means; and
selling said imprinted ticket to a player.

20. The method of producing a gaming ticket stock according to claim 10 wherein said thermal paper base sheet includes a notched portion.
